(19) United States
(12) Patent Application Publication
(10) Pub. No.: US 2008/0151873 A1
(43) Pub. Date: Jun. 26, 2008

(54) Virtual internet protocol interconnection service

(76) Inventor: Mike Borsetti, San Francisco, CA (US)

Correspondence Address: FISH & RICHARDSON P.C., PO BOX 1022, MINNEAPOLIS, MN, 55440-1022, US

(21) Appl. No.: 11/963,631

(22) Filed: Dec. 21, 2007

Related U.S. Application Data
(60) Provisional application No. 60/871,428, filed on Dec. 21, 2006.

(51) Int. Cl. H04L 12/66

(52) U.S. Cl. 370/352

(57) ABSTRACT

A bi-directional system for interconnecting devices on an Internet Protocol (IP) network, such as the Internet, is described. The bi-directional system employs an identifier scheme, such as telephone numbers, to identify the devices. The devices are communications devices, such as, but are not limited to, a telephone, computer, laptop, personal digital assistant, cell phone, video camera, videoconferencing system, or smart phone. The devices are network enabled and may be endpoints in IP Private Branch Exchange (PBX) systems, respectively. The devices may be interconnected by the bi-directional system to exchange communications in a peer to peer fashion. One or more devices may include a service that interconnects with a public switched telephone network (PSTN) such as, but is not limited to, a conferencing server, a voicemail system, an answering service, a multipoint-video mixing system or a mobile phone service.

### CROSS-REFERENCE TO RELATED APPLICATION

This application claims the benefit of U.S. Provisional Patent Application No. 60/871,428 entitled “VIRTUAL INTERNET PROTOCOL INTERCONNECTION SERVICE” filed on Dec. 21, 2006, the disclosure of which is incorporated herein by reference in its entirety.

### TECHNICAL FIELD

The present invention relates to network communications.

### BACKGROUND

Over the past century, telephone communications have become rather ubiquitous as the public switched telephone network (PSTN) has expanded into increasingly rural and other remote areas of every country, thus affording nearly universal telephone access. In operation, the PSTN provides real-time circuit-switched connections between the caller and called parties, i.e., it establishes a continuous real-time link between calling origination and destination, maintains the real-time link for the duration of a telephone call and ceases the connection upon termination of the call. Conventionally, calls are digitally coded and transmitted along a transmission line (e.g., T1 line or fiber optic cable) using circuit switching technology to transmit the calls. Such calls can be time division multiplexed (TDM) into separate channels, which allow many calls to pass over the lines without interacting. The channels can be directed independently through multiple circuit switches from an originating switch to a destination switch. Using conventional circuit switched communications, a channel on each transmission line along which a call is transmitted is dedicated for the duration of the call, whether or not any information is actually being transmitted over the channel. In such systems, a large amount of switching bandwidth is required to handle a high volume of voice calls.

Due to limiting bandwidth and increasing traffic congestion, conventional systems have attempted to convert the PSTN or portions thereof into a packet-switched network. In a packet-switched network, there is no single, unbroken physical connection between sender and receiver. The packets from many different calls share network bandwidth with other transmissions. The packets are sent over potentially many different routes at the same time toward the destination, and then are reassembled at the receiving end. The result is much more efficient use of network resources than could be achieved with circuit-switching.

### SUMMARY

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram showing an example of a system for interconnecting devices on an Internet Protocol (IP) network.

FIG. 2 is a block diagram showing an example of a distributed hash table system used when interconnecting devices on an Internet IP network.

FIG. 3 is a flow chart showing an example of a process for maintaining quality of service when interconnecting devices on an IP network.

FIG. 4 is a flow chart showing an example of a process for matching a communication device identifier with IP network connection information.

FIG. 5 is a flow chart showing an example of a process for interconnecting devices on an IP network.

Like reference symbols in the various drawings indicate like elements.

### DETAILED DESCRIPTION

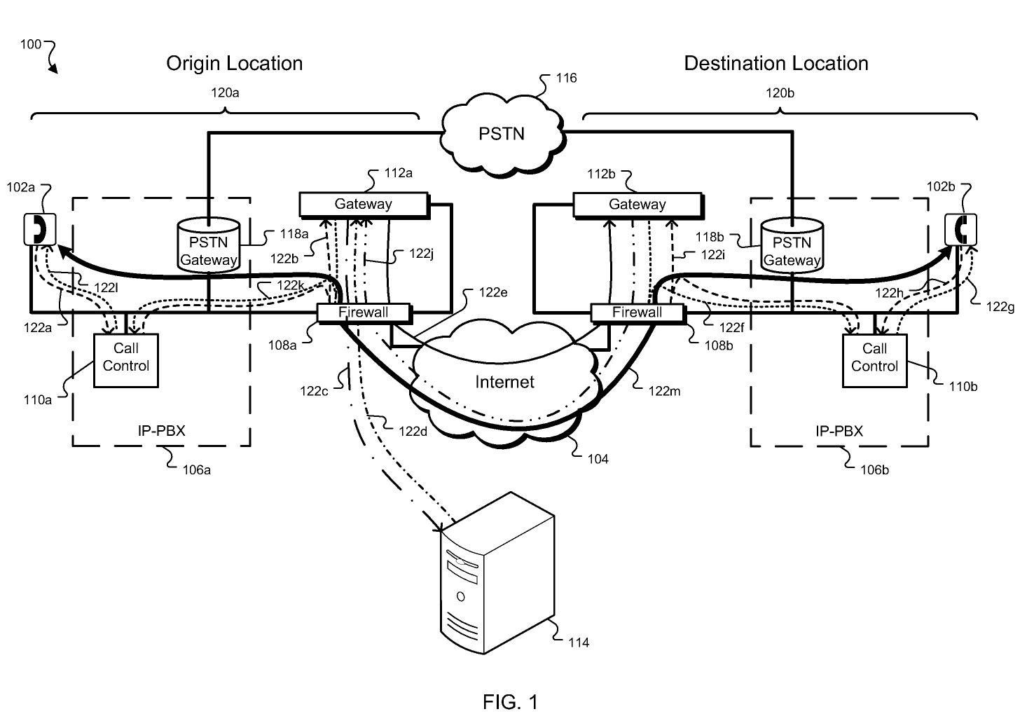

FIG. 1 is a schematic diagram showing an exemplary bi-directional system 100 for interconnecting devices 102a-b on an Internet Protocol (IP) network 104, such as the Internet. The system 100 uses an identifier scheme, such as telephone numbers, to identify the devices 102a-b. The devices 102a-b are communications devices, such as, but are not limited to, a telephone, computer, laptop, personal digital assistant, cell phone, video camera, videoconferencing system, or smart phone. In the particular example shown, the devices 102a-b are network enabled and may be endpoints in IP Private Branch Exchange (PBX) systems 106a-b, respectively. In one implementation, the devices 102a-b may be interconnected by the system 100 to exchange communications in a peer to peer fashion. In some implementations, one or both devices 102a-b may include a service that interconnects with a public switched telephone network (PSTN) such as, but is not limited to, a conferencing server, a voicemail system, an answering service, a multipoint-video mixing system or a mobile phone service.

The IP-PBX systems 106a-b may be connected to the network 104 through firewalls 108a-b, respectively. Within the IP-PBX systems 106a-b, call control devices 110a-b route calls dialed from the devices 102a-b, respectively. The call control devices 110a-b determine if calls dialed at the devices 102a-b are routed to another device within the IP-PBX systems 106a-b or to a device outside the IP-PBX systems 106a-b, respectively. If calls are routed outside the IP-PBX systems 106a-b, then the call control devices 110a-b route the calls to gateways 112a-b. In some implementations, the call control devices 110a-b bypass the firewalls 108a-b and route the calls directly to the gateway at the destination.

The gateways 112a-b can bi-directionally route messages or communications, such as voice over IP (VoIP) or video calls, through the network 104. The gateways 112a-b may include a table (not shown) of dialing information that associates an (e.g., dialed) identifier with IP connection information, such as, but are not limited to, an IP address or a list of IP addresses, a public/private key certificate, a User Datagram Protocol (UDP) port range, a caching expiration time, or other information. The gateways 112a-b use the IP connection information to establish an interconnection between devices, such as the devices 102a-b. Alternatively, a directory service 114 may store the table of IP connection information and the gateways 112a-b may retrieve the IP connection information from the directory service 114. The directory service 114 may be associated with the gateways 112a-b, and be included therein, co-located or remote therefrom. In a further example, a combination of devices (e.g., the directory service 114 and the gateways 112a-b) may store the IP connection information, such as in a distributed hash table. If the gateways 112a-b cannot establish a connection over the network 104 then the gateways 112a-b may route calls over another network, such as a public switched telephone network (PSTN) 116. Particularly, the gateways 112a-b may route calls over the PSTN 116 through PSTN gateways 118a-b.

The following is an example of a sequence of events that may occur when establishing an interconnection between the devices 102a-b. In this example, a user at an origin location 120a dials a call at the device 102a. The origin user intends to communicate with a user at a destination location 120b. The dialed identifier may be an International Telecommunication Union Telecommunication Standardization Sector (ITU-T) E.164 number or another format, such as a private identification including numeric, alphanumeric, special characters (e.g., UNICODE characters) or combination thereof assigned by the gateways 112a-b, service providers or users of devices 102a-b.

The device 102a sends a request 122a to the call control device 110a for an interconnection to the dialed identifier. The request 122a may use a protocol, such as Session Initiation Protocol (SIP), ITU-T H.323, Skinny Client Control Protocol (SCCP), or combination thereof. For example, the request 122a may be a SIP INVITE message including the dialed identifier.

The call control device 110a routes the interconnection request based on the dialed identifier. If the dialed identifier is not inside the IP-PBX system 106a, then the call control device 110a sends an interconnection request 122b to the gateway 112a, such as a SIP INVITE message.

The gateway 112a attempts to resolve the dialed identifier in the request 122b. The gateway 112a may look up the dialed identifier in a locally stored table, such as for example an identifier directory, a cache storing previously dialed identifiers, or a portion of a distributed identifier directory. In some implementations, the identifier directory, cache or distributed identifier directory can store pre-populated dialed identifiers or be updated with relevant information associated with the dial identifiers on a periodic or scheduled basis. If the gateway 112a cannot determine the IP connection information for the dialed identifier, then the gateway 112a sends a request 122c to the directory service 114. For example, the gateway 112a may use the Telephone Number Mapping (ENUM) protocols to send an SRV query, such as the “E2U+sip” query, to the directory service 114.

The directory service 114 sends a response 122d including the IP connection information to the gateway 112a. If using ENUM, the response 122d may be an SRV record including information, such as an IP address or a list of IP addresses, public key certificate, UDP port range, and caching expiration time. Alternatively, another protocol may be used, such as Simple Object Access Protocol (SOAP) over Secure Hypertext Transfer Protocol (HTTPS), Open Database Connectivity (ODBC) or OSP (Open Settlement Protocol)

If IP connection information associated with the dialed identifier cannot be found, then the gateway 112a and/or the call control device 110a may direct the interconnection request to another gateway, such as the PSTN gateway 118a. Otherwise, the gateway 112a sends a connection request 122e to a peer at the destination location 120b, such as the gateway 112b. In some implementations, the request 122e can include an initiation of a call session and an encrypted tunnel connection between the origin location 120a and the destination location 120b, such as with Transport Layer Security (TLS). If a prior encrypted tunnel connection has previously been established (e.g., for a previous call), or if a current encrypted tunnel connection is ongoing, the gateways 112a-b may reuse this previously established encrypted tunnel connection without establishing a new encrypted tunnel connection. An encryption tunnel connection can be established to prevent potential eavesdropping, tampering, message forgery and hacking by unauthorized parties.

The gateways 112a-b can authenticate the encryption tunnel connection using, for example, locally stored private certificates or a public key, such as a Rivest-Shamir-Adleman (RSA) public key, retrieved from the directory service 114. In some implementations, the gateways 112a-b are implemented with a transport layer security (TLS) layer operable to provide a reliable and transparent data transfer between the devices 102a-b. The TLS layer can provide a mechanism that allows data protection and data integrity between the devices 102a-b. In these implementations, mutual authentication is employed between the TLS layers of the gateways 112a-b to authenticate the encryption tunnel connection without the need to retrieve a public key, for example, from the directory service 114.

Quality of Service (QoS) can be an important issue in designing an efficient VoIP network. QoS of VoIP or videoconferencing calls can degrade due to congestion on a network or failure of network processing nodes in the network. QoS can include call sound quality and the ability and responsiveness of the IP network in establishing new VoIP or videoconferencing calls. Large delays and call data (i.e., packet) loss can contribute to poor QoS that can be burdensome in time sensitive applications (e.g., real-time video conferencing).

Thus, in some implementations, during the process of or after establishing a call session, each gateway 112a-b measures certain parameters based on the communication with the other gateway to predict/evaluate the quality of an actual call session. For example, each gateway 112a-b can monitor or measure one or more communications quality parameters, such as latency (delay for packet delivery), jitter (variations in delay of packet delivery), and packet loss (heavy traffic in a network that can cause the network to drop packets) on a scheduled or periodic basis. As an example, each gateway 112a-b can use the data exchanged in the process of establishing a call session and/or encryption tunnel, and/or inject a media stream (e.g., test data) through the network 104, to assess the quality of a call connection between the gateways 112a-b or end devices 102a-b. Each gateway 112a-b can predefine a threshold for each quality parameter or a computation thereof, such as, for example, a Mean Opinion Score (MOS) (e.g., ITU-T recommendation P.800) and based on a comparison between each measured or calculated quality parameter and associated threshold, each gateway 112a-b determines whether an actual call session, if established, would meet one or more quality requirements. The quality requirements also may be based on the particular origin location 120a and/or the destination location 120b of a call session.

If the media stream received by the gateway 112b reflects a decrease in quality of service (i.e., if the gateway determines that quality requirements are not met), then the gateway 112a or control device 102a can treat the condition as if the gateway 11b has rejected the interconnection request, and re-initiate the request through, for example, another gateway. As another option, the gateway 112a can establish a new connection or connect to a different internet protocol address in an attempt to complete the interconnection request. For example, the IP connection information may include multiple IP addresses at which the user at the destination location may be contacted. The selection of an IP address from the multiple IP addresses may be based on quality of service measurements. As yet another option, the gateway 112a can implement a timeout to the interconnection request, and re-evaluate the quality parameters after a predetermined time period. If the thresholds for the quality parameters are subsequently satisfied, the gateway 112b is notified of an interconnection request 122f. The gateway 112b then sends the interconnection request 122f to the call control device 110b. For example, the gateway 112b may send an SIP INVITE message to the call control device 110b.

The call control device 110b sends an interconnection request 122g to the device 102b. For example, the call control device 110b may send an SIP INVITE message to the device 102b.

The device 102b sends a response 122h to the call control device 110b indicating the status of the interconnection request 122g. For example, the device 102b may send a SIP TRYING message followed by a SIP OK message or another SIP status message if available.

The call control device 110b sends a response 122i to the gateway 112b. For example, the call control device 110b may send a SIP OK message or another SIP status message provided by the device 102b.

The gateway 112b sends a response 122j to the gateway 112a. For example, the gateway 112b may send a SIP OK message or another SIP status message provided by the device 102b.

The gateway 112a sends a response 122k to the call control device 110a. For example, the gateway 112a may send a SIP OK message or another SIP status message provided by the device 102b. In addition, before sending the response 122k, the gateway 112a may modify Session Description Protocol (SDP) data or similar message (e.g., consistent with ITU-T protocols such as H.323) to apply a connection policy. For example, while the SDP data as received by the call control device 110a may indicate that the device 102a supports various codecs, the gateway 112a may replace some or all the SDP data with information indicating that the device 102a only supports a particular codec, such as ITU-T G.711. The replacement may be based on a predetermined rule. For example, the gateway 112a may specify a codec based on results of the quality requirements checks. The gateway 112a also can determine the path of the encrypted portion of the interconnection between the devices 102a-b. For example, if the SDP data of each of the devices 102a-b indicates support for encryption, then the devices 102a-b may be directly interconnected and gateways 112a-b may mediate an encryption protocol negotiation based on predetermined parameters (e.g., protocols including cipher and decipher strength, level of security and the like) and key exchange. In some implementations, each device may be configured with an encryption standard different from the other device. For example, the device 102a can specify an encryption protocol using a 64-bit key, while the device 102b can specify an encryption protocol using a 128-bit key. In these implementations, the device 102b can reject the interconnection request if it is determined that the tunnel connection is encrypted based on a 64-bit standard rather than the 128-bit standard as specified by the device 102b. In general, the gateways 112a-b determine if connection policy parameters, such as encryption strength, are met by a particular network scenario. The gateways 112a-b may include predetermined connection policy parameters which they enforce when establishing an interconnection. In certain implementations, the receiving gateway determines if a set of interconnection properties meets the predefined connection policy parameters.

In another implementation, if the device 102b does not support encryption, then the encrypted portion of the interconnection may be managed through the device 102a and the gateway 112b. Conversely, if the device 102a does not support encryption, then the encrypted portion of the interconnection may be handled through the device 102b and the gateway 112a. If neither of the devices 102a-b support encryption, then the encrypted portion of the interconnection may be supervised through the gateways 112a-b.

Alternatively or in addition, the encrypted path may be based on predetermined settings at the gateways 112a-b and/or the devices 102a-b. The encrypted path may also be based on the results of the quality requirements. For example, if a particular path does not meet the quality requirements another path may be attempted. In addition, the topology of the network 104 or the configuration of the firewalls 108a-b may prevent a direct encrypted interconnection between one or more of the devices 102a-b. Regardless, in some implementations, the gateway 112a places the information regarding the encryption path in the SDP data and sends the SDP data to the call control device 110a.

The call control device 110a sends a response 122l to the device 102a. For example, the call control device 110a may send a SIP OK message or another SIP status message provided by the device 102b. In addition, the call control device 110a sends the SDP as modified by the gateway 112a.

The device 102a uses the SDP to establish an encrypted interconnection session 122m to the destination location 120b, such as a direct connection to the device 102b. The devices 102a-b may use a protocol, such as Secure Real-time Transport Protocol (SRTP), for the direct encrypted interconnection session 122m. Alternatively, the previously described interconnections using either or both of the gateways 112a-b may be used.

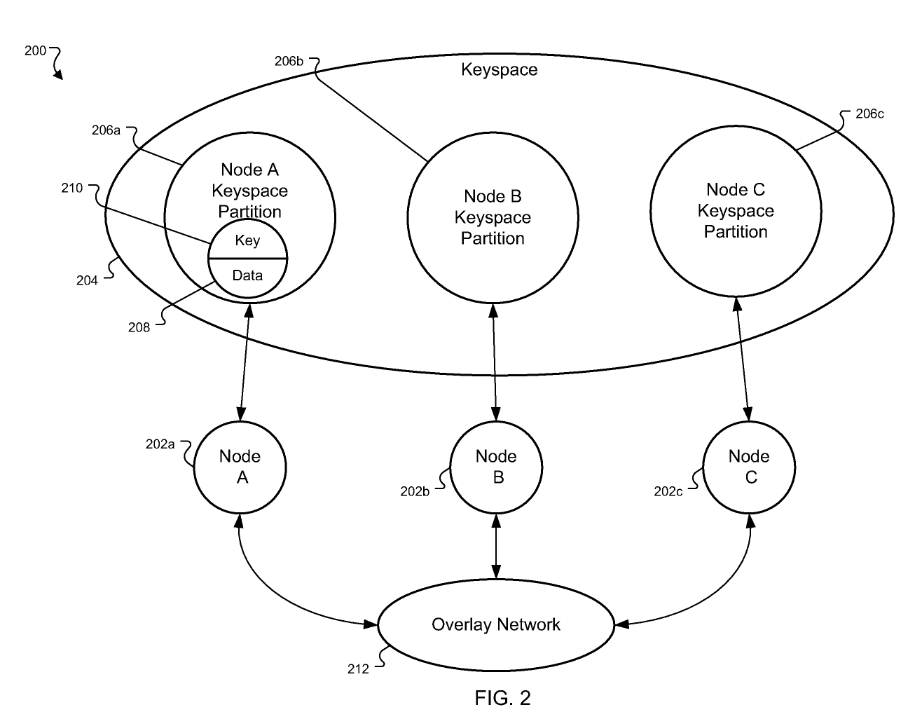

FIG. 2 is a block diagram showing an example of a distributed hash table system 200 used when interconnecting devices on a VoIP and/or video network. The system 200 includes nodes 202a-c. The nodes 202a-c can be of the form of devices, such as the gateways 112a-b and the server 114, that the identifier directory is distributed over. Each set of IP connection information and its associated identifier in the identifier directory can be identified by a key. The entire space of directory entry and key pairs are represented by a keyspace 204. Each of the nodes 202a-c is responsible for partitions 206a-c of the keyspace 204, respectively. The partitions 206a-c may be stored locally at the nodes 202a-c, respectively, or otherwise.

For example, the identifier dialed in the previous example at the device 102a and its IP connection information may be represented as data 208. The data 208 has an associated key 210 that identifies and locates the data 208 in the keyspace 204 and the partition 206a. The node 202a provides the data 208 when the key 210 is used as a request.

Requests for data may be made over an overlay network 212. For example, the network 104 may be an overlay network. In the previously described sequence of interconnection events, upon receiving the dialed identifier, the gateway 112a uses the dialed identifier to create the key 210. For example, the gateway 112a may use the Secure Hash Algorithm (SHA) to generate the key 210 from the dialed identifier. Each of the nodes 202a-c has an identifier. An algorithm may be used to determine if a particular key is within a partition of a node based on the key and the identifier of the node. If the gateway 112a determines that the key 210 is not within its partition keyspace, then the gateway 112a can make a request to the overlay network 202 for the data 208 using the key 210. In some implementations, the gateway 112a may use a list of node identifiers to locate a next likely node to handle the key 210. The key 210 is passed around the overlay network 202 until it reaches the node 202a. The node 202a retrieves the data 208, including the IP connection information, and sends the data to the gateway 112a. The IP connection information is then used to create the interconnection between the devices 102a-b.

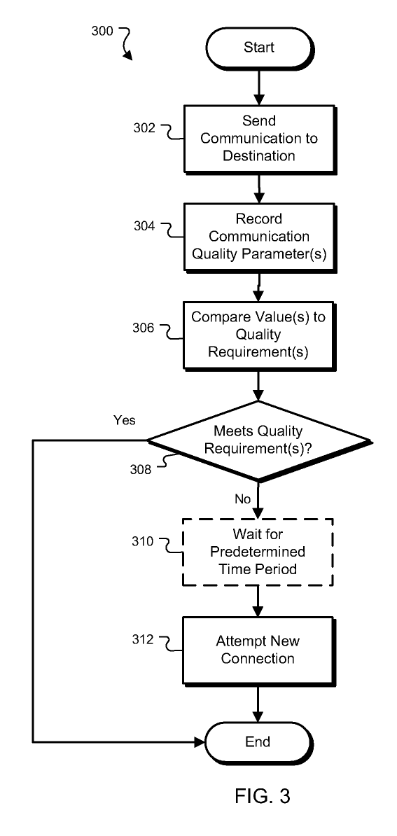

FIGS. 3, 4, and 5 are flow charts showing examples of processes 300, 400, and 500. The processes 300, 400, and 500 may be performed, for example, by a system such as the system 100. For clarity of presentation, the description that follows uses the system 100 as the basis of an example for describing the processes 300, 400, and 500. However, another system, or combination of systems, may be used to perform the processes 300, 400, and 500.

FIG. 3 is a flow chart showing an exemplary process 300 for maintaining quality of service when interconnecting devices on an IP network. The process 300 begins with sending (302) a communication to a destination. For example, the gateway 112a sends the request 122e to the gateway 112b at the destination location 120b. The gateway 112a may also send additional test data traffic to the gateway 112b.

The process 300 records (304) communication quality parameters. For example, the gateway 112a records the latency, jitter, and packet loss in the communication to the gateway 112b.

The process 300 compares (306) communication quality parameter values to communication quality requirements. For example, the gateway 112a may compare values for the latency, jitter, and packet loss, or a computation thereof such as, but not limited to, a Mean Opinion Score (MOS) to threshold values for each of the parameters or computation thereof.

If the communication quality parameter values do not meet the communication quality requirements (308), then the process 300 optionally waits (310) for a predetermined time period. For example, if the gateway 112a determines that the latency exceeds a latency threshold, then the gateway 112a may incorporate a delay into transmissions before sending a request to use another gateway.

The process 300 attempts (310) a new connection. For example, if the devices 102a-b support the encryption required by the gateway 112b and/or the gateway 112a, then the gateways 112a-b may be bypassed and a direct interconnection between the devices 102a-b is established. In some implementations, direct connection between the device 102a-b takes place for the data stream, while session set-up packets are directed through the gateways 112a-b. In another implementations, if the device 102a supports the required encryption and the device 102b does not, the device 102a to establish an interconnection with the device 102b by connecting through the gateway 112b. Conversely, if the device 102b supports the required encryption and the device 102a does not, then the gateway 112b may be bypassed allowing the device 102a to establish an interconnection with the device 102b by connecting through the gateway 112a.

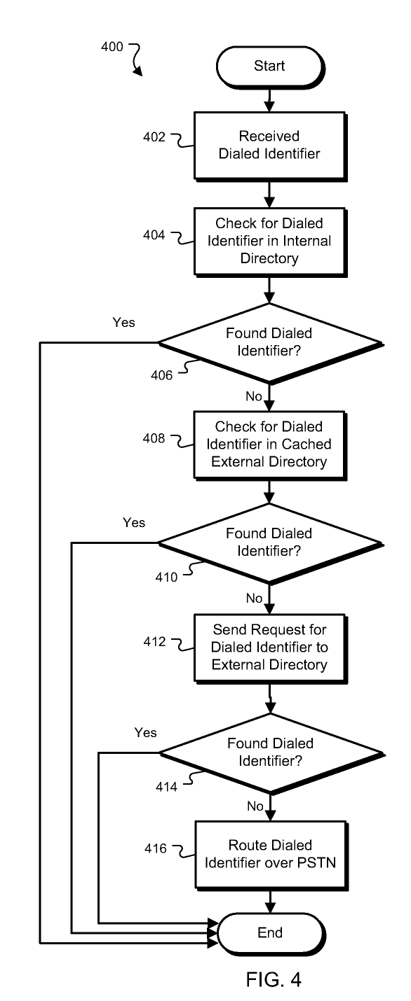

FIG. 4 is a flow chart showing an exemplary process 400 for matching a communication device identifier with IP network connection information. The process 400 begins with receiving (402) a dialed identifier. For example, a user at the device 102a dials an identifier and the gateway 112a receives the identifier via the call control device 110a.

The process 400 checks (404) for the dialed identifier in directory (e.g., an internal directory). For example, the gateway 112a may include an identifier directory or a portion of a distributed identifier directory. In some implementations, the identifier directory, cache or distributed identifier directory can store pre-populated dialed identifiers or be updated with relevant information associated with the dial identifiers on a periodic or scheduled basis.

If the dialed identifier and its associated IP connection information are found (406), the process 400 ends. Otherwise, the process 400 checks (408) for the dialed identifier in a cached list of dialed identifiers from an alternative (e.g., an external) directory. For example, the gateway 112a may have the IP connection information for the dialed identifier in a cached history previously received from the directory service 114.

If the dialed identifier and its associated IP connection information are found (410), the process 400 ends. Otherwise, the process 400 sends (412) a request for the dialed identifier to the alternative directory. For example, the gateway 112a may send the request 122c for IP connection information associated with the dialed identifier.

If the dialed identifier and its associated IP connection information are found (414), the process 400 ends. Otherwise, the process 400 routes the connection for the dialed identifier over an alternative network (e.g., the PSTN). For example, the gateway 112a may send a message to the call control device 110a indicating that IP connection information could not be found and the connection request is then sent to the PSTN gateway 118a.

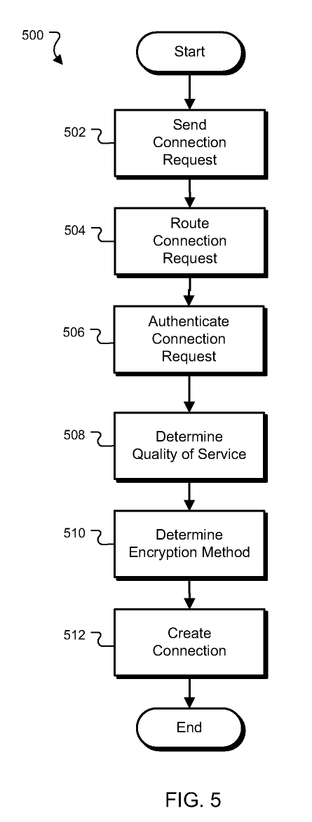

FIG. 5 is a flow chart showing an exemplary process 500 for interconnecting devices on an Internet Protocol (IP) network. The process 500 begins with sending (502) a connection request. For example, the device 102a sends the connection request 122a to the call control device 110a after a user dials an identifier.

The process 500 routes (504) the connection request. For example, for calls outside the IP-PBX system 106a, the call control device 110a routes the connection request 122a to the gateway 112a.

The process 500 authenticates (506) the connection request. For example, the gateways 112a-b may have private certificates or may receive a public key from the directory service 114 for use in authentication.

The process 500 determines (508) quality of service. For example, the gateway 112a may record communication quality parameters and compare the recorded values to quality thresholds to maintain connection quality requirements.

The process 500 optionally determines (510) an encryption method. For example, based on the quality requirements, gateway configuration settings, configured minimum requirements, and/or encryption abilities of the devices 102a-b, the gateway 112a determines the path of the encrypted interconnection between the origin location 120a and the destination location 120b.

The process 500 creates (512) a connection. For example, the gateway 112a modifies the SDP for the device 102a and forwards the SDP along with the response 122h from the device 102b to the call control device 110a. The call control device 110a then forwards the information to the device 102a and the device 102a communicates over the connection 122m.

Although a few implementations have been described in detail above, other modifications are possible. For example, in some implementations, the system 100 may include a gatekeeper (not shown). The gatekeeper may be an entity (e.g. H.323) within the system 100 that provides network services such as address translation (e.g., from a H.323 call identifier or E.164 number to an IP address) and network access control for H.323 terminals, gateways and other network components. For example, the gatekeeper can restrict access to the gateways 112a-b during a particular time of day, or receive and forward call requests appropriately to respective devices. The gatekeeper also may maintain active call information and use the information to indicate whether the devices 102a-b are busy such that all incoming calls should be re-routed. If desired, the gatekeeper also can provide other services such as bandwidth management and dial schemes that can be centralized to achieve communication scalability and stability.

In some implementations, the gatekeeper may be in continuous communication with the gateways 112a-b. Conventional signaling protocols may be used to supplement such communications. The gatekeeper may be configured to direct call requests to respective gateways 112a-b (or devices 102a-b). For example, a user may use the device 102a to initiate a call to device 102b. The user may dial a phone number associated with device 102b. The gateway 112a then sends a call or admission request to the gatekeeper requesting permission to communicate with device 102b. The gatekeeper looks up its directory to determine if device 102b is registered. If so, the gatekeeper can return an admission confirmation with the IP address of gateway 112b (or device 102b) to the gateway 112a (or user of device 102a). In response, gateway 112a may send a call-setup message to gateway 112b with the phone number of device 102b. Upon receipt, gateway 112b sends an admission request to the gatekeeper requesting permission to answer the call initiated by the user of device 102a. If it is confirmed that device 102a is legitimate (e.g., if device 102a also is registered), then the gatekeeper can issue an admission confirmation with the IP address of gateway 112a (or device 102a) to the gateway 112b (or user of device 102b). Gateway 112b then sets up a call to device 102b at the dialed number. When device 102b answers, gateway 102b sends a connection message to gateway 102a. At this time, both gateways send a information request response message to the gatekeeper acknowledging that the call has been setup.

If a gatekeeper is not available, the gateways 112a-b may periodically attempt to detect a new or different gatekeeper. If it is determined that the gatekeeper has gone off-line, the gateways 112a-b may cease to accept new calls or call requests until a new gatekeeper is detected or the previous gatekeeper is activated again.

While only one gatekeeper has been described, one ordinary skill in the art would appreciate that there can be more than one gatekeeper in the system 100. In these implementations, the gatekeepers may communicate with the other to execute the foregoing call setup process.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Nevertheless, it will be understood that various modifications may be made without departing from the spirit and scope of the following claims. For example, devices shown in the drawings, such as the call control devices 110a-b, the PSTN gateways 118a-b, the gateways 112a-b, may represent a cluster of devices that are used for purposes, such as physical redundancy, connectivity redundancy, and geographical redundancy. Accordingly, other implementations are within the scope of the following claims.

What is claimed is:

1. A method comprising:
requesting a connection request from a sender;
authenticating the connection request by a first gateway and sending the authenticated request to a second gateway without using a centralized service for requesting connection; and
transmitting the authenticated connection request to a recipient by the second gateway.

2. A method comprising:
initiating a first communication with a receiving device;
recording one or more parameters associated with the communication;
comparing the one or more parameters with one or more corresponding predetermined threshold values;
establishing a second communication with the receiving device if the one or more parameters satisfies the one or more corresponding predetermined threshold values.

3. The method of claim 2, further comprising
reinitiating the first communication after a predetermined time period if the one or more parameters does not satisfy the one or more corresponding predetermined threshold values.

4. A method comprising:
receiving a dialed identifier;
locating the dialed identifier in an internal directory including an identifier directory;
sending a request for the dialed identifier to an external directory if the dialed identifier is not located in the identifier directory; and
associating the dialed identifier with an internet protocol parameter, the internet protocol parameter being used to initiate a call request to a sender.

5. The method of claim 4, further comprising routing the dialed identifier to a public switched telephone network if the dialed identifier is not located in the external directory.

6. The method of claim 4, further comprising updating the identifier directory with previous dialed identifiers on a schedule or period basis.

7. The method of claim 4, further comprising storing pre-populated dialed identifiers in the identifier directory.

8. A method comprising:
sending a connection request;
routing the connection request to a gateway device;
authenticating the connection request;
determining one or more quality parameters associated with the connection request;
comparing the one or more quality parameters with one or more corresponding predetermined threshold values used for maintaining connection quality measurements;
determining an encrypted connection path based on the comparison; and
establishing a communication between the sending device and the receiving device, the sending device and the receiving device communicating on the encrypted connection path.

9. The method of claim 8, wherein sending a connection request includes receiving a dialed identifier and generating the connection request based on the dialed identifier.
